(19) United States
(12) Patent Application Publication
(10) Pub. No.: US 2010/0183949 A1
(43) Pub. Date: Jul. 22, 2010

(54) FUEL CELL CASE

(76) Inventor: Haruhisa Niimi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/664,122

(22) PCT Filed: Jun. 12, 2008
(86) PCT No.: PCT/JP2008/061171

§ 371 Date: Dec. 11, 2009

(30) Foreign Application Priority Data
Jun. 22, 2007 (JP) 2007-165336

(51) Int. Cl. H01M 2/08

(52) U.S. Cl. 429/508

(57) ABSTRACT

A fuel cell case (10) has a fuel cell installation structure (30) to be fixed to a fuel cell (20) and also has a case body (32) to which the fuel cell installation structure (30) is mounted and which receives the fuel cell (20). The fuel cell installation structure (30) includes a seat base (34) fixed to end plates (24, 26) of the fuel cell (20) by a first bolt (82), a seat plate fixed to the case body (32), and an insulation base body (38) for integrating the seat base (34) and the seat plate (36) together in an insulated manner. The insulation base body (38) has a bolt hole (42) into which the first bolt (82) is inserted and also has a neck portion (44) protruding to the outside of the case body (32). The case body (32) has an opening (60) for preventing interference between the case body (32) and the neck portion (44) of the fuel cell installation structure (30) and also has a cover (90) for covering the neck portion (44). Seal members (46, 47, 48) are arranged between the case body (32) and the insulation base body (38).

### TECHNICAL FIELD

The present invention relates to a fuel cell case, and more particularly to a fuel cell case which includes a fuel cell installation structure to be fixed to a fuel cell and a case body to which the fuel cell installation structure is mounted and which stores the fuel cell therein.

### BACKGROUND ART

Fuel cells have recently been in the limelight due to the high efficiency and excellent environmental characteristics. In general, fuel cells produce electrical energy when hydrogen, which is fuel gas, and oxygen in the air, which is oxidizer gas, undergo electrochemical reaction. As a result of the electrochemical reaction between hydrogen and oxygen, water is generated.

Types of fuel cells include phosphoric acid fuel cells, molten carbonate fuel cells, solid oxide fuel cells, alkaline fuel cells, polymer electrolyte fuel cells, and so on. Among these types of fuel cells, polymer electrolyte fuel cells having an advantage that they can be started at room temperature and at a high speed and so on have attracted attention. The polymer electrolyte fuel cells are being used as a power source of a moving body, such as a vehicle, for example.

A polymer electrolyte fuel cell is assembled by layering a plurality of single cells, a current collector, an end plate, and so on. The fuel cell is then stored in a fuel cell case in order to ensure dust proofing, water proofing, and so on. Here, Patent Document 1, for example, discloses an assembling device for a fuel cell, which is configured to include a mount member having an inner cylindrical fitting fixed to a fuel cell, an outer cylindrical fitting fixed to a support body, a rubber elastic material which is interposed between these fittings and which is deformable in the horizontal and vertical directions, and bolts and nuts for fastening the mount member to the fuel cell and the support body at the inner cylindrical fitting and the outer cylindrical fitting, respectively. Further, a fuel cell case storing a fuel cell therein is fixed to a body of a vehicle by a frame and so on.

Patent Document 1: JP 2002-235801 A

### DISCLOSURE OF THE INVENTION

### Problems to be Solved by the Invention

Here, when mounting a fuel cell installation structure such as the mount member or the like to the case body of the fuel cell case as described above, there is a possibility that water enters the inside of the fuel cell case from the outside of the fuel cell case through an interface between the fuel cell installation structure and the case body. In order to prevent this possibility, bolts and other members for fastening the fuel cell installation structure to the end plate of the fuel cell are provided with a waterproofing cap or the like and ensure insulation property, for example. However, protection of the bolt or the like with a cap and so on as described above would increase the number of processing steps, which leads to problems of a reduction in the productivity of the fuel cell case and an increase in the manufacturing costs.

To address the above disadvantages, the present invention advantageously provides a fuel cell case in which entering of water into the inside of the case body can be suppressed.

### Means for Solving the Problems

In accordance with an aspect of the present invention, there is provided a fuel cell case for storing a fuel cell, including a fuel cell installation structure to be fixed to a fuel cell; and a case body to which the fuel cell installation structure is mounted and which stores the fuel cell therein, wherein the fuel cell installation structure includes a seat base fixed to an end plate of the fuel cell by a first bolt; a seat plate fixed to the case body; and an insulation base body which integrates the seat base and the seat plate together in an insulated manner, wherein the insulation base body includes a neck portion having a bolt hole through which the first bolt is inserted and protruding to the outside of the case body, and the case body includes an opening for avoiding the neck portion of the fuel cell installation structure and a cover for covering the neck portion of the fuel cell installation structure, and wherein a seal member is provided between the case body and the insulation base body.

In accordance with another aspect of the invention, there is provided a fuel cell case for storing a fuel cell, including a fuel cell installation structure to be fixed to a fuel cell; and a case body to which the fuel cell installation structure is mounted and which stores the fuel cell therein, wherein the fuel cell installation structure includes a seat base fixed to an end plate of the fuel cell by a first bolt; a seat plate fixed to the case body; and an insulation base body which integrates the seat base and the seat plate together in an insulated manner, wherein the insulation base body includes a neck portion having a bolt hole through which the first bolt is inserted and protruding to the outside of the case body, and the case body includes an opening for avoiding the neck portion of the fuel cell installation structure and a cover for covering the neck portion of the fuel cell installation structure, and wherein the cover includes a flange, the flange being fixed to an inner surface of the case body, and a seal member is provided between the flange and the insulation base body.

In the fuel cell case according to the present invention, the fuel cell installation structure includes a second bolt which is provided on the seat plate and is fixed to the case body, and the seal member is provided on an outer circumference of the second bolt.

### Advantage of the Invention

As described above, with the fuel cell case according to the present invention, by sealing a gap between the fuel cell installation structure and the case body, entering of water into the inside of the case body can be suppressed.

### BRIEF DESCRIPTION OF THE DRAWINGS

These and other objects of the invention will be explained in the description below, in connection with the accompanying drawings, in which:

FIG. 1 is a view illustrating a fuel cell case according to an embodiment of the present invention;

FIG. 2A is a plan view illustrating a structure of a fuel cell installation structure according to the embodiment of the invention;

FIG. 2B is a cross sectional view illustrating a structure of the fuel cell installation structure according to the embodiment of the invention;

FIG. 3 is a view illustrating placement of a seal member according to the embodiment of the present invention;

FIG. 4 is a view illustrating a case body for storing a fuel cell according to the embodiment of the present invention;

FIG. 5 is a cross sectional view illustrating a cover which covers a neck portion of the fuel cell installation structure according to the embodiment of the present invention;

FIG. 6 is a view illustrating an installation method for installing a cover on a case body according to the embodiment of the present invention;

FIG. 7A is a cross sectional view, taken along line A-A of FIG. 6, for illustrating a case body on which a cover is installed according to the embodiment of the present invention;

FIG. 7B is a cross sectional view, taken along line B-B of FIG. 6, for illustrating a case body on which a cover is installed according to the embodiment of the present invention;

FIG. 8 is a cross sectional view illustrating a fuel cell installed on a case body with a fuel cell installation structure according to the embodiment of the present invention; and

FIG. 9 is a cross sectional view illustrating a fuel cell installed on a case body with a fuel cell installation structure according to another embodiment of the present invention.

### DESIGNATION OF NUMERALS

10: fuel cell case
20: fuel cell
22: single cell
24, 26: end plate
30: fuel cell installation structure
32: case body
34: seat base
36: seat plate
38: insulation base body
40: second bolt
42: bolt hole
44: neck portion
46, 47, 48: seal member
52: flange portion
54: fastening hole
56: cable hole
58: reinforcing member
60: opening
62, 76: second bolt hole
70, 90: cover
72: cover body
74: flange
80: welding portion
82: first bolt
84: nut

### BEST MODE FOR CARRYING OUT THE INVENTION

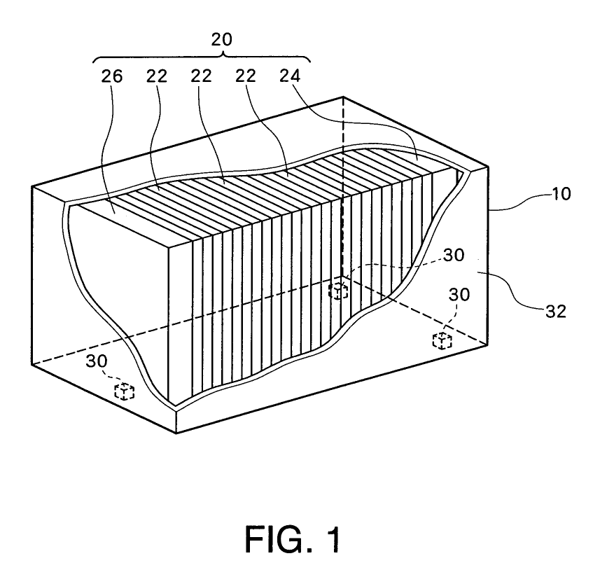

Preferred embodiments of the present invention will be described in detail with reference to the drawings. FIG. 1 is a view illustrating a fuel cell case 10. The fuel cell case 10 illustrated in FIG. 1 stores a fuel cell 20 therein. The fuel cell 20 includes a fuel cell stack which is composed of a plurality of single cells 22 and current collectors and so on that are layered, and end plates 24 and 26 placed at both ends of the fuel cell stack.

The single cell 22 includes an electrolyte membrane, a catalyst layer, a gas diffusion layer, and a separator. Among these layers, the electrolyte membrane, the catalyst layer, and the gas diffusion layer are integrated to form what is generally referred to as a membrane electrode assembly (MEA).

The electrolyte membrane has a function of shifting hydrogen ions generated on the anode electrode side to the cathode electrode side. As a material of the electrolyte membrane, an ion exchange membrane of a fluorine resin which is chemically stable, such as perfluoro-carbon sulfonic acid, is used, for example.

The catalyst layer has a function of accelerating the oxidation reaction of hydrogen on the anode electrode side and the reduction reaction of oxygen on the cathode electrode side. The catalyst layer includes a catalyst and a carrier of the catalyst. The catalyst is generally in a particulate form and is adhered to the carrier of catalyst for use, in order to increase the electrode area to be used for reaction. For the catalyst, platinum, which is a platinum element having a small activation overvoltage, or the like is used. As the carrier of the catalyst, a carbon material, e.g. carbon black, is used.

The gas diffusion layer has a function of diffusing a fuel gas, such as hydrogen gas, and oxidizer gas, such as air, in the catalyst layer and a function of shifting electrons, and so on. For the gas diffusion layer, carbon fiber woven fabric, carbon paper, and so on, which are materials having conductivity, can be used. Then, the membrane electrode assembly can be manufactured by layering the electrolyte membrane, the catalyst layer, and the gas diffusion layer and applying heat pressing and so on to these layers.

The separator is layered on the gas diffusion layer of the membrane electrode assembly and has a function of separating the fuel gas and the oxidizer gas between the adjacent single cells 22. The separator also has a function of electrically connecting the adjacent single cells 22. The separator includes a gas channel through which the fuel gas and the oxidizer gas flow, a coolant channel through which a coolant such as an LLC (Long Life Coolant) and cooling water for cooling the single cell 22 flow, and so on, that are formed therein. The separator can be formed of a metal material such as stainless steel, a carbon material, and so on, which have conductivity.

The current collector has a function of extracting a direct current generated in the plurality of single cells 22 which are layered. The current collector can be formed of a metal material such as stainless steel or copper, a carbon material, and so on, which have conductivity. Further, in the current collector, the metal sheet member such as stainless steel or copper may be plated with gold.

The end plates 24 and 26 are disposed on the respective end portions of the fuel cell stack. The end plates 24 and 26 can be formed of a metal material such as stainless steel, for example. The end plates 24 and 26 include a supply port for supplying the fuel gas, the oxidizer gas, and the coolant, and a discharge port for discharging the fuel gas, the oxidizer gas, and the coolant.

Next, the fuel cell case 10 will be described. The fuel cell case 10 includes a fuel cell installation structure 30 to be fixed to the fuel cell 20 and a case body 32 to which the fuel cell installation structure 30 is mounted and which stores the fuel cell 20 therein.

The fuel cell installation structure 30 is mounted on the case body 32 and has a function of insulating the fuel cell case 10 from the fuel cell 20. The fuel cell installation structure 10 also has a function of absorbing vibration of the fuel cell 20 when the fuel cell 20 is excited. The fuel cell installation structure 30 is fixed to a position supporting one end portion on the lower surface of one end plate 24, a position supporting other end portion on the lower surface of the one end plate 24, and a position supporting the substantially center portion on the lower surface of the other end plate 26, for example. By supporting the fuel cell 20 at three points as described above, it is possible to suppress torsion or the like of the fuel cell 20 to thereby prevent leakage of the coolant or the like due to shift of the layered single cells 22. It is obvious, however, that placement of the fuel cell installation structure 30 is not limited to the above example depending on other conditions.

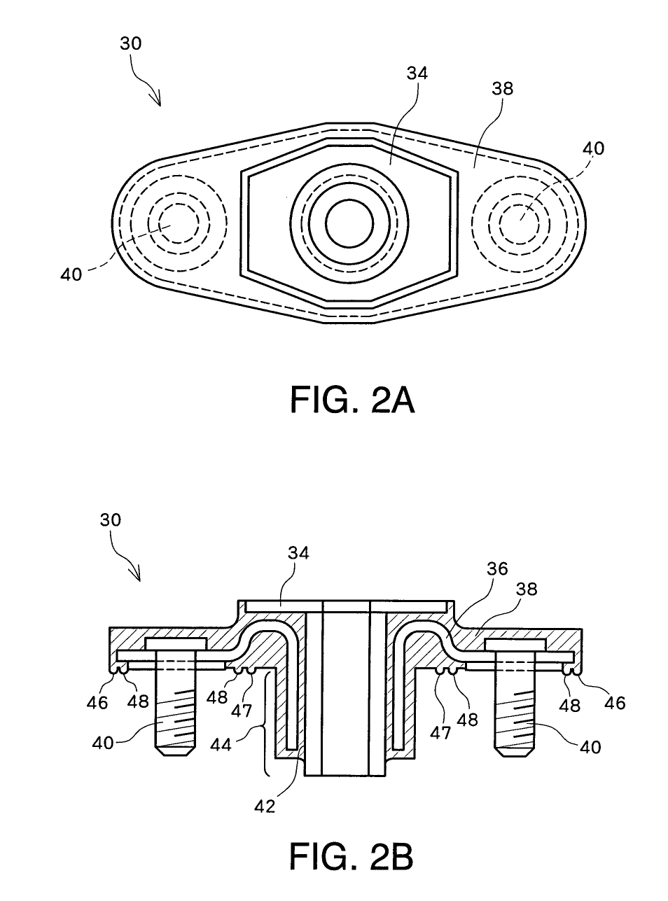

FIGS. 2A and 2B illustrate a structure of the fuel cell installation structure 30. Specifically, FIG. 2A is a plan view of the fuel cell installation structure 30 and FIG. 2B is a cross sectional view of the fuel cell installation structure 30. The fuel cell installation structure 30 includes a seat base 34 to be fixed to the end plate 24, 26 with a first bolt, a seat plate 36 to be fixed to the case body 32, and an insulation base body 38 which integrates the seat base 34 and the seat plate 36 together in an insulated manner.

The seat base 34 includes a flange portion which abuts against the end plate 24, 26 of the fuel cell 20 and a cylindrical portion through which the first bolt is inserted. Second bolts 40 are provided at two points of the seat plate 36 for fixing to the case body 32. The seat base 34 and the seat plate 36 are formed using a metal material such as an iron alloy and an aluminum alloy.

The insulation base body 38 has a function of integrating the seat base 34 and the seat plate 36 together in an insulated manner. A rubber material or the like having an insulation property can be used for the insulating base body 38, for example. The insulation base body 38 includes a bolt hole 42 into which the first bolt 82 is inserted and also includes a neck portion 44 protruding to the outside of the case body 32. The fuel cell installation structure 30 can be molded as an integral unit by injecting an unvulcanized rubber which is a raw material of the insulation base body 38, into a die in which the seat base 34 and the seat plate 36 are placed, and bridging the unvulcanized rubber.

The insulation base body 38 includes a plurality of seal members 46, 47, and 48 on the case body side 32 so as to prevent entry of water or the like from the outside of the fuel cell case 10. The seal members 46, 47, and 48 are preferably formed of an elastic material such as a rubber material, because the seal members 46, 47, and 48 made of an elastic material can elastically deform to provide a seal against leakage of water and so on. Obviously, the materials of the seal members 46, 47, and 48 are not limited to the elastic materials depending on other conditions.

The seal members 46, 47, and 48 are formed integrally with the insulation base body 38 by providing projections on the case body 32 side of the insulation base body 38, for example. Because the insulation base body 38 is formed of a rubber material and so on, the projections formed on the case body 32 side of the insulation base body 38 are elastically deformed to thereby reduce entry of water. Alternatively, it is also possible to form a seal groove on the insulation base body 38 on the case body 32 side and fit the seal members 46, 47, and 48 formed of a rubber material such as an O ring into the seal groove. In addition, the seal members 46, 47, and 48 may be bonded to the insulation base body 38 by an adhesive and so on. Here, depending on other conditions, the seal members 46, 47, and 48 may be mounted on the case body 32 and the like.

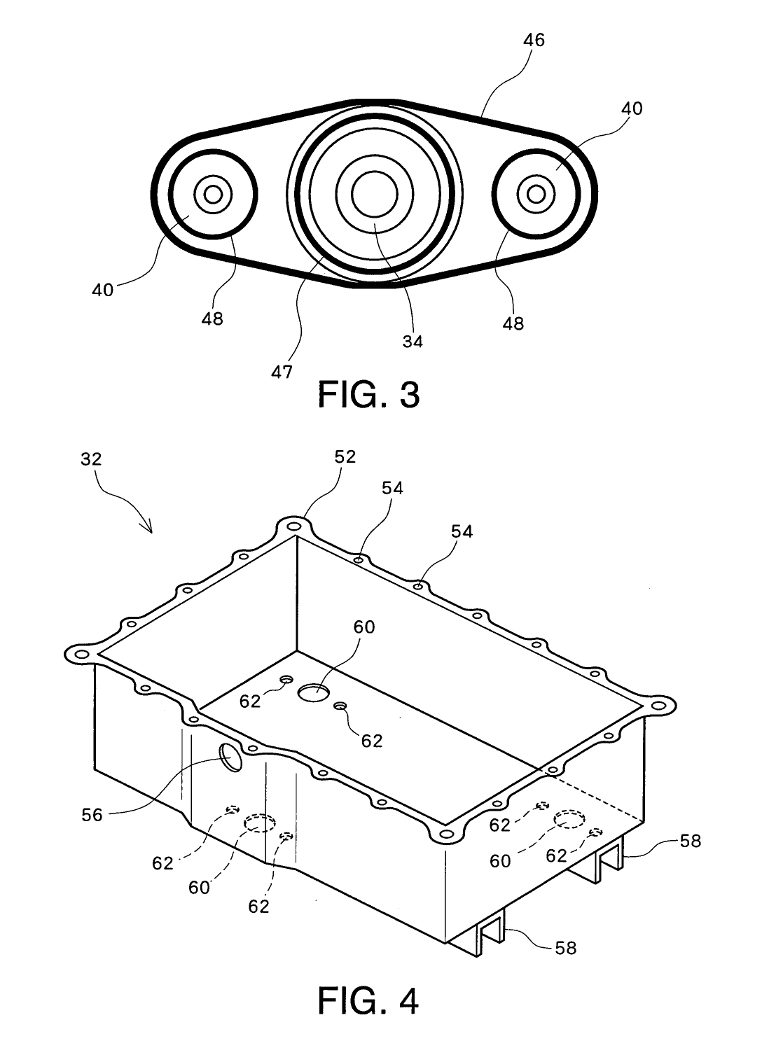

FIG. 3 is a view illustrating the placement of the seal members 46, 47, and 48. More specifically, FIG. 3 is a schematic view of the fuel cell installation structure 30 illustrated in FIGS. 2A and 2B seen from the case body 32 side. In FIG. 3, the seal members 46, 47, and 48 are provided at a plurality of positions on the insulation base body 38. Specifically, the seal member 46 is provided on the outer circumference of the insulation base body 38, and the seal member 47 is provided on the outer circumference of the neck section 44 of the insulation base body 38. With this placement, it is possible to prevent water or the like from entering the inside of the fuel cell case 10 from the outside of the insulation base body 38. Further, it is preferable to provide the seal member 48 on the outer circumference of each second bolt 40. By providing the seal member 48 on the outer circumference of the second bolt 40, it is possible to further prevent entry of water into the inside of the case body 32 from the periphery of the second bolt 40, so that the sealing property can be increased. As the two second bolts 40 are provided in the example illustrated in FIG. 3, the seal members 48 are also provided at two positions.

The case body 32, to which the fuel cell installation structure 30 is attached, has a function of storing the fuel cell 20. FIG. 4 is a view illustrating the case body 32 for storing the fuel cell 20. The case body 32 is divided into two portions, of which a lower portion of the case body 32 is illustrated in FIG. 4. The case body 32 includes a flange portion 52 in which a plurality of fastening holes 54 are provided for fastening the upper portion and the lower portion of the case body 32 together with a fastening member such as a bolt. The case body 32 can be molded by plastic processing or the like by using a metal material such as an iron alloy, an aluminum alloy, and so on. Obviously, the case body 32 may be molded as a single integral unit rather than being divided into two portions.

Preferably, the inner surface of the case body 32 is coated with a rubber material, a synthetic resin material, and so on, which have an insulation property. With the inner surface of the case body 32 coated with an insulating material, insulation properties can be ensured between the fuel cell and the fuel cell case 10. Further, a cable hole 56 through which a cable such as a ground lead extends is provided on the case body 32.

Preferably, the case body 32 is provided with a reinforcing member 58 at the mounting position for the fuel cell installation structure 30, because the load of the fuel cell 20 is applied intensively to the mounting position for the fuel cell installation structure 30 on the case body 32. When the fuel cell installation structure 30 is mounted on the case body 32 at three positions, for example, the load of the fuel cell 20 is intensively applied to these three mounting positions. Accordingly, the reinforcing members 58 are provided at these three positions to thereby reinforce the case body 32. For the reinforcing member 58, a rib which is molded with a metal material such as an iron alloy, an aluminum alloy, and so on is used. The reinforcing member 58 is bonded to the case body 32 by welding, for example.

The case body 32 includes an opening 60 formed therein for avoiding the neck portion 44 of the fuel cell installation structure 30. When the fuel cell installation structure 30 is mounted on the case body 32 at three positions, for example, the opening 60 is also formed in the case body 32 at three positions. Further, a second bolt hole 62 through which the second bolt 40 is inserted is provided at two positions near the opening 60 formed in the case body 32. The opening 60 and the second bolt hole 62 can be formed by boring the case body 32 by means of general machining processing of a metal material.

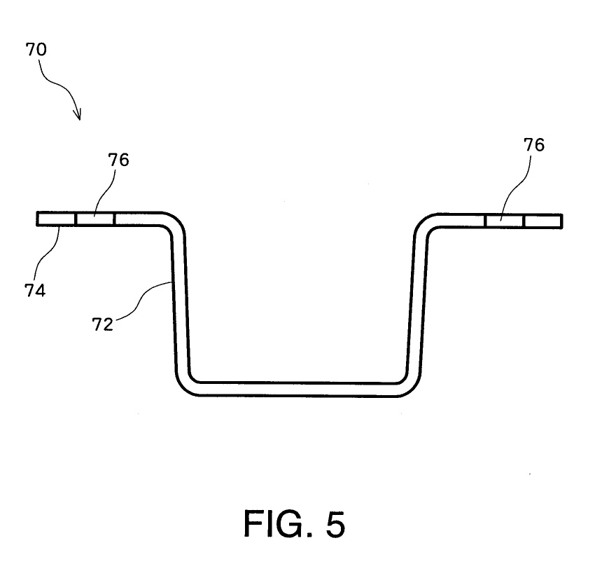

The case body 32 is also provided with a cover which covers the neck portion 44 of the fuel cell installation structure 30. FIG. 5 is a cross sectional view illustrating a cover 70 covering the neck portion 44 of the fuel cell installation structure 30. With this cover 70, entry of water, dust, and so on into the inside of the case body 32 from the outside of the case body 32 can be prevented. Also, because the first bolt to be fastened to the end plates 24 and 26 of the fuel cell 20 is inserted into the bolt hole 42 of the neck section 44 of the fuel cell installation structure 30, provision of the cover 70 can prohibit contact with the first bolt. As illustrated in FIG. 5, the cover 70 includes a cover body 72 which receives the neck section 44 of the fuel cell installation structure 30, and a flange portion 74 provided around the cover body 72. Further, the flange 74 includes a second bolt hole 76 through which the second bolt 40 is inserted at two positions therein. The cover 70 is molded as an integral unit by plastic processing such as press processing of an iron alloy sheet, an aluminum alloy sheet, and so on, for example.

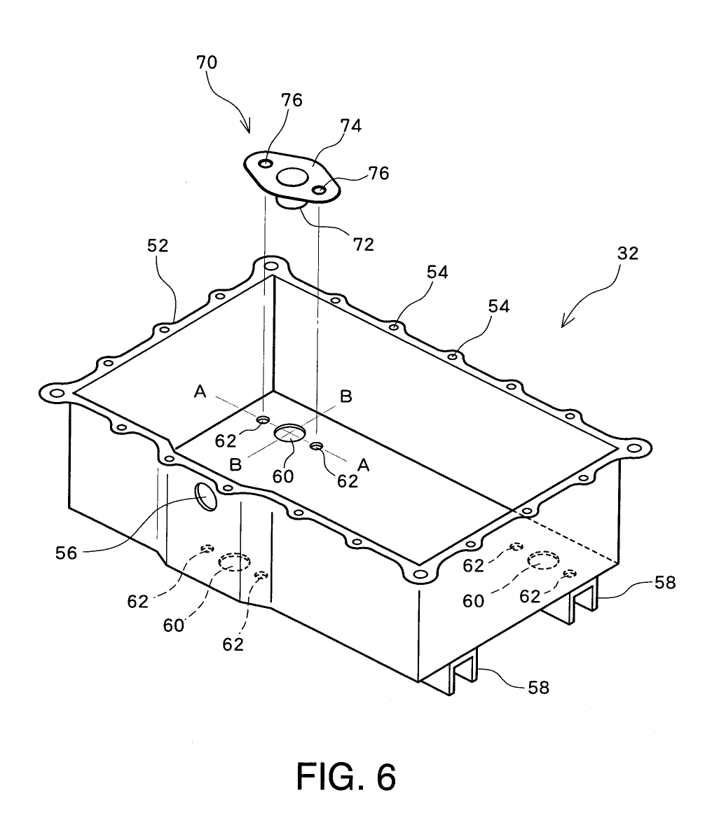

FIG. 6 is a view illustrating the mounting method for mounting the cover 70 onto the case body 32. As illustrated in FIG. 6, the cover 70 is mounted from the inside of the case body 32. The cover body 72 is fitted in the opening 60 formed in the case body 32. Then, the flange 74 of the cover 70 is fixed to the inner surface of the case body 32. Also, the cover 70 is mounted such that the second bolt hole 76 provided in the flange 74 is substantially aligned with the second bolt hole 62 provided in the case body 32. In this manner, by fitting the cover body 72 in the opening 60 of the case body 32 to make the flange 74 abut against the inner surface of the case body 32, the cover 70 is positioned with respect to the case body 32. Then, the cover 70 is fixed to the case body 32 by welding and so on.

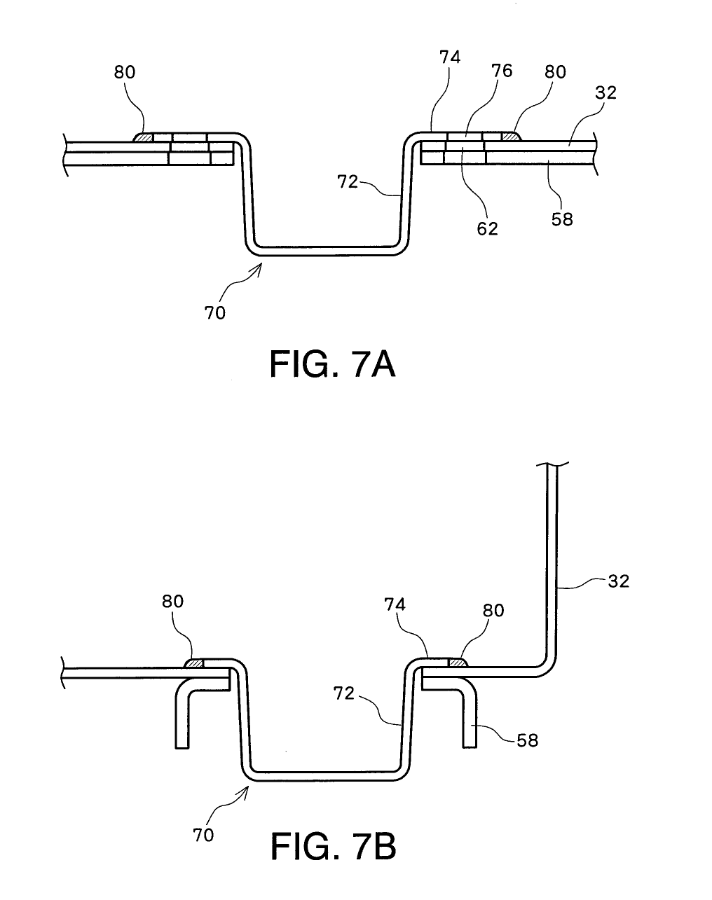

FIGS. 7A and 7B are cross sectional views illustrating the case body 32 to which the cover 70 is mounted. Specifically, FIG. 7A is a cross sectional view taken along line A-A of FIG. 6 and FIG. 7B is a cross sectional view taken along line B-B of FIG. 6. As illustrated in FIG. 7A or 7B, by fitting the cover body 72 in the opening 60 of the case body 32 to make the flange 74 abut against the inner surface of the case body 32, the cover 70 is positioned with respect to the case body 32. At this time, the second bolt hole 76 provided in the flange 74 is substantially aligned with the second bolt hole 62 provided in the case body 32. Also, it is preferable that the welding portion 80 for bonding the flange 74 and the inner surface of the case body 32 is provided so as to avoid the position at which the seal member 46, 47, or 48 formed in the insulation base body 38 is provided. With this structure, it is possible to prevent overlapping of the seal members 46, 47, and 48 with the welding portion 80, so that the sealing property by means of the seal members 46, 47, and 48 can be increased. Here, the welding portion between the flange 74 and the inner surface of the case body 32 is provided on the outer circumference of the flange 74 as illustrated in FIG. 7A or 7B, for example.

The method of installing the fuel cell 20 in the fuel cell case 10 will now be described.

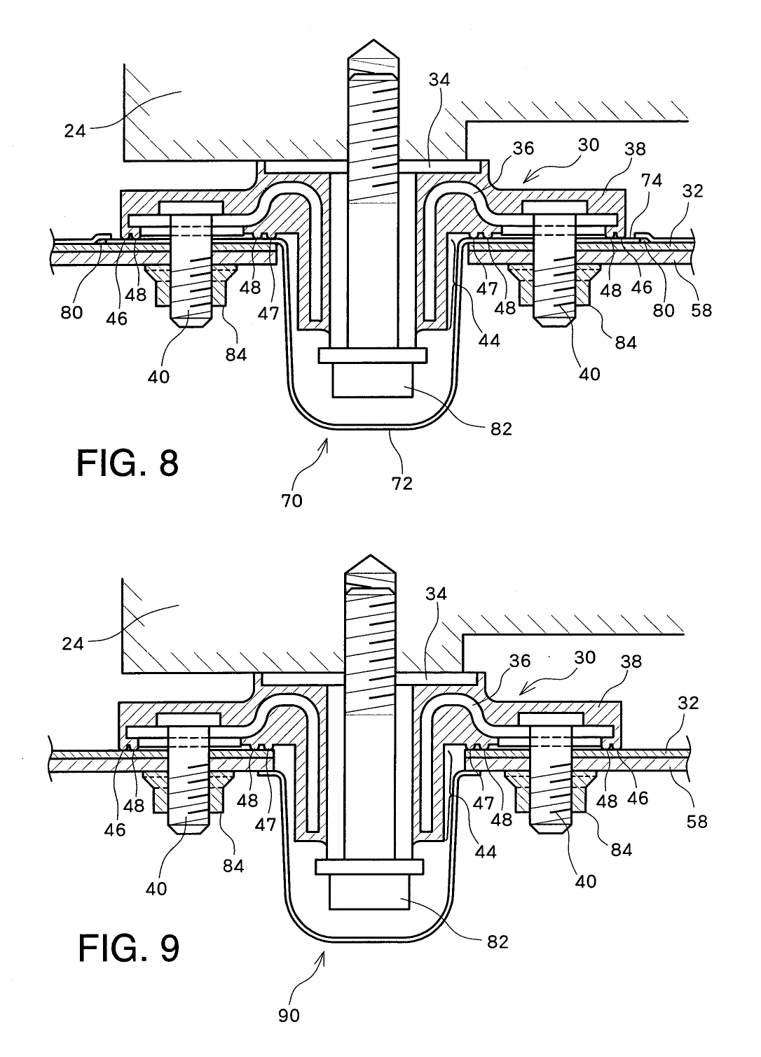

FIG. 8 is a cross sectional view illustrating a state in which the fuel cell 20 is installed in the case body 32 using the fuel cell installation structure 30. As described above, the cover 70 is previously fixed to the inner surface of the case body by the flange 74 by means of welding. First, the first bolt 82 inserted into the seat base 34 of the fuel cell installation structure 30 is fastened to the end plate 24, 26 of the fuel cell 20 to thereby fix the fuel cell installation structure 30 onto the fuel cell 20. Then, the neck section 44 of the fuel cell installation structure 30 is housed in the cover body 72 and the two second bolts provided in the seat plate 36 of the fuel cell installation structure 30 are inserted into the second bolt holes 62 and 76 provided in the flange 74 of the cover 70 and the case body 32, respectively. Subsequently, the fuel cell installation structure 30 fixed to the fuel cell 20 is fixed to the case body 32 by the second bolts 40 and the nuts 84. With this processing, the fuel cell installation structure 30 fixed to the fuel cell 20 is mounted on the case body 32, so that the fuel cell 20 is stored in the fuel cell case 10.

Here, because the seal members 46, 47, and 48 are provided between the insulation base body 38 of the fuel cell installation structure 30 and the flange 74 of the cover 70, it is possible to prevent water from entering the inside of the fuel cell case 10 from between the insulation base body 38 and the flange 74. Further, with the seal member 48 provided on the outer circumference of the second bolt 40, entry of water from the second bolt holes 62 and 76 can be further suppressed. Also, as the welding portion 80 for bonding the flange 74 and the case body 32 is formed so as to avoid the seal members 46, 47, and 48 formed on the insulation base body 38, the sealing properties of the seal members 46, 47, and 48 disposed between the insulation base body 38 and the flange 84 can be enhanced.

While in the above structure, the flange 74 of the cover 70 is fixed to the inner surface of the case body 32, the cover 70 may be fixed to the outer surface of the case body 32. FIG. 9 is a view illustrating a state in which the fuel cell 20 is installed in the case body 32 by the fuel cell installation structure 30. As illustrated in FIG. 9, the cover 90 is fixed to the reinforcing member 58 provided outside of the case body 32 by welding and so on. In this case, because the seal members 46, 47, and 48 are provided between the insulation base body 38 of the fuel cell installation structure 30 and the case body 32, it is possible to prevent water from entering the inside of the fuel cell case 10 from between the insulation base body 38 and the case body 32.

As described above, with the above structure, because the seal members are provided between the insulation base body of the fuel cell installation structure and the flange of the cover, it is possible to prevent water from entering the inside of the fuel cell case from between the insulation base body and the flange. This structure can eliminate the need for providing a cap or the like for insulation or water-proofing to the first bolt which fixes the fuel cell installation structure to the fuel cell, so that productivity of the fuel cell case can be further increased and the manufacturing costs can be further reduced.

With the above structure, by providing the seal members between the insulation base body of the fuel cell installation structure and the case body, entry of water into the inside of the fuel cell case from between the insulation base body and the case body can be reduced, even when the cover is provided on the outside of the case body.

With the above structure, by providing the seal member on the outer circumference of the second bolt, entry of water into the inside of the case body from the second bolt hole can be further suppressed.

1. (canceled)

2. A fuel cell case for storing a fuel cell, comprising:
a fuel cell installation structure to be fixed to a fuel cell; and
a case body to which the fuel cell installation structure is mounted and which stores the fuel cell therein,
wherein the fuel cell installation structure includes:
a seat base fixed to an end plate of the fuel cell by a first bolt;
a seat plate fixed to the case body;
an insulation base body which integrates the seat base and the seat plate together in an insulated manner; and
a second bolt which is provided on the seat plate and fixed to the case body,
wherein the insulation base body includes a neck portion having a bolt hole through which the first bolt is inserted and protruding to the outside of the case body, and the case body includes an opening for avoiding the neck portion of the fuel cell installation structure and a cover for covering the neck portion of the fuel cell installation structure, and
wherein the cover includes a flange, the flange being fixed to an inner surface of the case body, and a seal member in a rib shape is provided on each of an outer circumference of the insulation base body, an outer circumference of the neck portion, and an outer circumference of the second bolt between the flange and the insulation base body.

3. (canceled)
